(19) United States
(12) Patent Application Publication
(10) Pub. No.: US 2008/0310617 A1
(43) Pub. Date: Dec. 18, 2008

(54) Transmission Links

(75) Inventors: Dirk Martin Daecke, Munich (DE); Mario Traeber, Diesenhofen (DE); Heinrich Schenk, Munich (DE); Robert Heilmann, Munich (DE); Mathias Riess, Munich (DE)

Correspondence Address: COATS & BENNETT/INFINEON TECHNOLOGIES, 1400 CRESCENT GREEN, SUITE 300, CARY, NC, 27518, US

(73) Assignee: INFINEON TECHNOLOGIES AG, Neubiberg (DE)

(21) Appl. No.: 11/762,909

(22) Filed: Jun. 14, 2007

(51) Int. Cl. H04M 9/08

(52) U.S. Cl. 379/406.08

(57) ABSTRACT

A device is provided for measuring properties of transmission links by an adaptive filter. The device comprises a first output terminal adapted to provide a first signal to the transmission link. Further, the device includes a first input terminal for receiving an echo signal of the first signal. An adaptive filter forms a part of the device and is coupled to the first input terminal. The device includes a second output terminal for providing information identifying filter coefficient of the adaptive filter.

### BACKGROUND OF THE INVENTION

This invention relates to transmission links.

The quality of the data transmission to customer premises depends on properties of the transmission links, such as for example in wired transmission on the properties of subscriber line copper wires. In view of the above, methods and devices to evaluate the properties of the transmission wires are useful.

### BRIEF DESCRIPTION OF THE SEVERAL VIEWS OF THE DRAWINGS

FIG. 1 schematically illustrates a circuit diagram of a device 100 according to an exemplary embodiment.

FIG. 2 schematically illustrates a circuit diagram of a device 200 according to an exemplary embodiment.

FIG. 3 schematically illustrates a circuit diagram of a device 300 according to an exemplary embodiment.

FIG. 4 schematically illustrates a circuit diagram of a system 400 according to an exemplary embodiment.

FIG. 5 schematically illustrates a circuit diagram of a device 500 according to an exemplary embodiment.

FIG. 6 shows a plot of an echo impulse response.

FIG. 7 schematically illustrates a circuit diagram of an adaptive filter 700.

FIGS. 8A to 8E show plots of impulse responses.

FIG. 9 schematically illustrates a circuit diagram of a device 900 according to an exemplary embodiment.

FIG. 10 schematically illustrates a circuit diagram of a device 1000 according to an exemplary embodiment.

FIG. 11 shows a plot of a noise power spectral density.

FIG. 12 schematically illustrates a circuit diagram of a prediction error filter according to an exemplary embodiment.

FIG. 13 shows a model of the device 1000.

FIG. 14 schematically illustrates a circuit diagram of a DSL transceiver.

### DETAILED DESCRIPTION OF THE INVENTION

In the following embodiments of the invention are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of embodiments of the invention. It may be evident, however, to one skilled in the art that one or more aspects of the embodiments of the invention may be practiced with a lesser degree of these specific details. In other instances, known structures and devices are shown in block diagram form in order to facilitate describing one or more aspects of the embodiments of the invention. The following description is therefore not to be taken in a limiting sense, and the scope of the invention is defined by the appended claims.

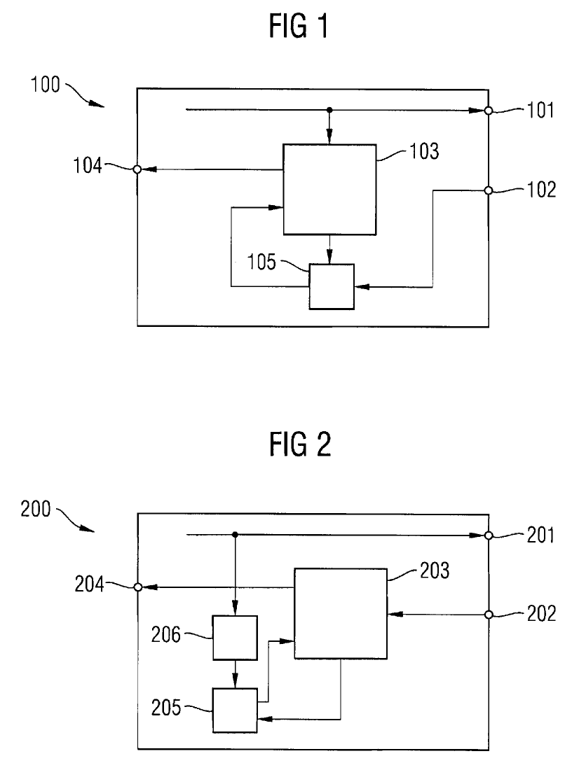

Referring now to FIGS. 1 to 3, embodiments of devices are shown wherein each of the devices is capable of measuring one or more various properties of transmission links by utilizing an adaptive filter. In FIG. 1 a schematic circuit diagram of a device 100 is illustrated. The device 100 comprises a first output terminal 101, a first input terminal 102, an adaptive filter 103 and at least one second output terminal 104. At the first output terminal 101 a first signal is provided and is transmitted via a transmission link. A first echo signal caused by the reflection of the first signal is received at the first input terminal 102. The reflection of the first signal may, for example, be due to an impedance mismatch within the transmission link or at its termination. The adaptive filter 103 adjusts its filter coefficients to the impulse response of the first echo signal. The filter coefficients of the adaptive filter 103 are provided at the second output terminal 104 to internal or external circuit components or circuit blocks, for example an evaluation unit or a determination unit as will be described in more detail below.

The device 100 may further comprise an error signal generator 105 having two input terminals, which are connected to the first input terminal 102 and an output terminal of the adaptive filter 103. An output terminal of the error signal generator 105 is connected to a control terminal of the adaptive filter 103. The error signal generator 105 produces an error signal by comparing the first echo signal and the output signal of the adaptive filter 103. The error signal is used to control the adaptive filter 103. The adaptive filter 103 may simulate the transfer function of the transmission link over which the first signal and its echo, the first echo signal, are transmitted.

The device 100 may be a transceiver, for example a modem, used for data transmission between a central office and a subscriber. The device 100 or parts of it which comprise the adaptive filter 103 may be an echo canceler.

In FIG. 2 a schematic circuit diagram of a device 200 is illustrated. Similar to the device 100, the device 200 comprises a first output terminal 201, a first input terminal 202, an adaptive filter 203 and at least one second output terminal 204 to provide filter coefficients to internal or external circuit components or circuit blocks other than the adaptive filter 203, for example to an evaluation unit as will be described in more detail below.

The device 200 may further comprise an error signal generator 205 and, as a further option, may comprise a delay element 206. The delay element 206 delays the first signal. The error signal generator 205 generates an error signal by comparing the delayed first signal and the output signal of the adaptive filter 203. The error signal controls the adaptive filter 203.

In contrast to the device 100, the adaptive filter 203 of the device 200 may produce the inverse impulse response of the first echo signal. The device 200 or parts of it, which comprise the adaptive filter 203, may be an equalizer.

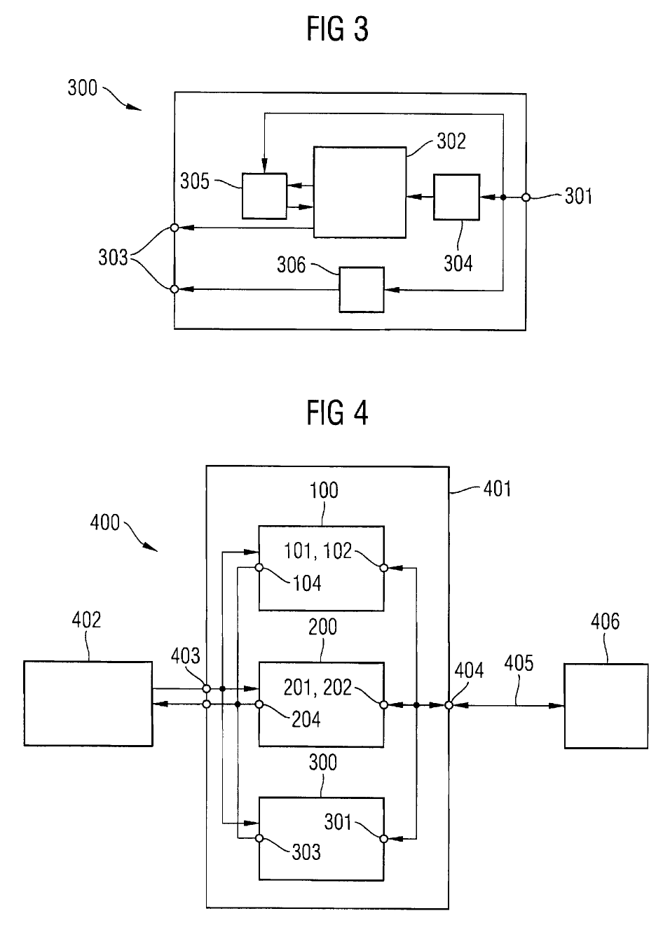

In FIG. 3 a schematic circuit diagram of a device 300 is illustrated. The device 300 comprises a first input terminal 301, an adaptive filter 302 and at least one first output terminal 303. At the first input terminal 301 a noise signal from a transmission link is received. The adaptive filter 302 adjusts its filter coefficients to the noise signal. The filter coefficients of the adaptive filter 302 are provided at the at least one first output terminal 303. The device 300 or parts of it, which comprise the adaptive filter 302, may be a prediction error filter.

The device 300 may further comprise a delay element 304, an error signal generator 305 and a determination circuit 306. The delay element 304 delays the received noise signal and feeds the adaptive filter 302 with the delayed noise signal. The error signal generator 305 produces an error signal by comparing the received noise signal and an output signal of the adaptive filter 302. The error signal controls the adaptive filter 302. The determination circuit 306 determines the power of the noise signal and outputs the determined power at the at least one first output terminal 303.

In the above exemplary embodiments reference was made to transmission links. The transmission links may, for example, be hard-wired transmission lines, optical fibers or other dedicated point-to-point connections or other time invariant channels. For reasons of simplifications, it is only referred to hard-wired transmission lines in the following. It is however to be understood that when reference is made to transmission lines, the transmission lines may be replaced by other types of transmission links.

In FIG. 4 a schematic circuit diagram of a system 400 is illustrated. The system 400 comprises a transceiver 401 and an evaluation and control unit 402. The transceiver 401 has an input and output interface 403 and a bi-directional terminal 404. The transceiver 401 comprises the devices 100, 200 and/or 300. The evaluation and control unit 402 is coupled to the transceiver 401 via the input and output interface 403. The output terminals 104, 204 and 303 of the devices 100, 200 and 300 are coupled to at least one input terminal of the evaluation and control unit 402 via the input and output interface 403. Furthermore, an output terminal of the evaluation and control unit 402 is coupled to control terminals of the devices 100, 200 and 300 via the input and output interface 403. The output terminals 101 and 201 as well as the input terminals 102, 202 and 301 of the devices 100, 200 and 300 are coupled to the bi-directional terminal 404. The bi-directional terminal 404 is coupled to an end of a transmission line 405. The other end of the transmission line 405 may be coupled to a further transceiver 406. The transceiver 406 may serve as a termination of the transmission line 405 and may be switched off during the evaluation phase of the loop when the first signals are sent by the transceiver 401. It may also be provided that there is no further transceiver 406 coupled to the other end of the transmission line 405. The transceiver 401 may be either located at the subscriber premises or in a local office. The transceivers 401 and 406 may, for example, be modems. The transmission line 405 may, for example, be a pair of twisted wires. The evaluation and control unit 402 may, for example, be a computer.

The transmission line 405 may form a telecommunication channel. The data transmission link over the telecommunication channel may either use the entire available frequency spectrum or it shares the frequency band with voice services. Voice services such as voiceband telephony (plain old telephony service—POTS) or ISDN typically use the lower portion of the frequency band, while data services can use the remaining frequency band. For data transmission there are a number of single carrier or multi carrier based services available. Examples for single carrier based transmission services that use PAM (Pulse Amplitude Modulation) are SHDSL (Symmetric High Bit Rate Digital Subscriber Line, also known in Europe as SDSL (Symmetric Digital Subscriber Line)) or HDSL2 (High Bit Rate Digital Subscriber Line 2). QAM-based single-carrier VDSL is also known. Examples for multi carrier based transmission services that use DMT (Discrete Multi Tone) modulation are ADSL (Asymmetric Digital Subscriber Line) or VDSL2 (Very High Bit Rate Digital Subscriber Line 2) or other services.

The quality of the data transmission via the transmission line 405 may be characterized by the maximum data transmission rate, which is also denoted as channel capacity. Parameters on which the maximum data transmission rate depends are among others the transfer function of the transmission line 405 and the noise power spectral density. Moreover, the transfer function depends on the length, the physical properties and the topology of the transmission line 405.

In order to evaluate data transmission via the transmission line 405 so-called secondary parameters are determined by the devices 100, 200 and/or 300 located in the transceiver 401. Secondary parameters are, for example, channel impulse responses and noise signals. The secondary parameters and scaling factors used for determining absolute values of the secondary parameters are transferred to the evaluation and control unit 402.

The evaluation and control unit 402 calculates so-called primary parameters using the secondary parameters measured by the devices 100, 200 and/or 300. The primary parameters are, for example, the length and the transfer function of the transmission line 405 as well as the noise power spectral density and information on bridged taps. The primary parameters provide information about the quality of the data transmission via the transmission line 405.

Measurements in the devices 100, 200 and/or 300 may be carried out in the time or frequency domain. The evaluation and control unit 402 may convert time domain parameters into frequency domain parameters and vice versa.

A further task of the evaluation and control unit 402 may be to configure the devices 100, 200 and/or 300 as well as to control their measurements. For that purpose, control signals are transferred to the devices 100, 200 and/or 300 informing them, for example, on the physical value to be measured, the frequency range to be measured, the number of filter coefficients, the time range, the resolution and the duration of the measurements. Furthermore, the accuracy of the measurement results may be enhanced by iteratively adjusting the control parameters.

For measuring the properties and the topology of the transmission line 405, adaptive filters are used that can adapt their filter tap coefficients to the echo impulse response. An adaptive filter self-adjusts its transfer function according to an optimizing algorithm. After running the optimizing algorithm, the filter coefficients of the adaptive filters correspond to properties of the transmission line 405 or to parameters from which these properties can be derived.

In FIG. 5 a schematic circuit diagram of a device 500 is illustrated. The device 500 represents one implementation of the device 100 shown in FIG. 1. The configurations of the device 500 described below may therefore be equally applied to the device 100. Apart from the first input and output terminals 101, 102, which are combined in one bi-directional terminal in the device 500, the adaptive filter 103, the at least one second output terminal 104 and the error signal generator 105, which is implemented as an adder, the device 500 comprises a digital-to-analog converter 106, an analog-to-digital converter 107, a hybrid 108 and an output terminal 110.

The digital-to-analog converter 106 converts the digital data to be transmitted to analog signals. The analog signal is fed into a transmission line 109 to be evaluated through the hybrid 108. The hybrid 108 is basically an electrical bridge that avoids leakage of the transmit signal into the receive path. In this way the transceiver can use the same frequency band in the transmit and in the receive directions. The transmit signal is coupled to the first input/output terminal 101, 102. Signals that are received at the first input/output terminal 101, 102 are digitized by the analog-to-digital converter 107.

In order to evaluate the transmission line 109, the device 500 may transmit a random sequence of data, for example scrambled symbols, as a first signal. The power density of the random sequence may be uniformly distributed over a given transmission frequency band. The transmitted first signal is reflected due to impedance mismatches within the transmission line 109 and at the termination. For example, the termination at the far-end side of the transmission line 109 determines the reflection of the transmitter signal. Reflections can also be caused by bridged taps (unused junctions of the loop). It is to be noted that reflection does not only occur at the remote end of the transmission line 109, but also at the interface between the device 500 and the transmission line 109. This kind of echo is called near-end echo, whereas the echo occurring at the receiver's end (far-end side) is called far-end echo. The overall received first echo signal is a combination of the near-end echo, the far-end echo and possibly further echos due to bridged taps.

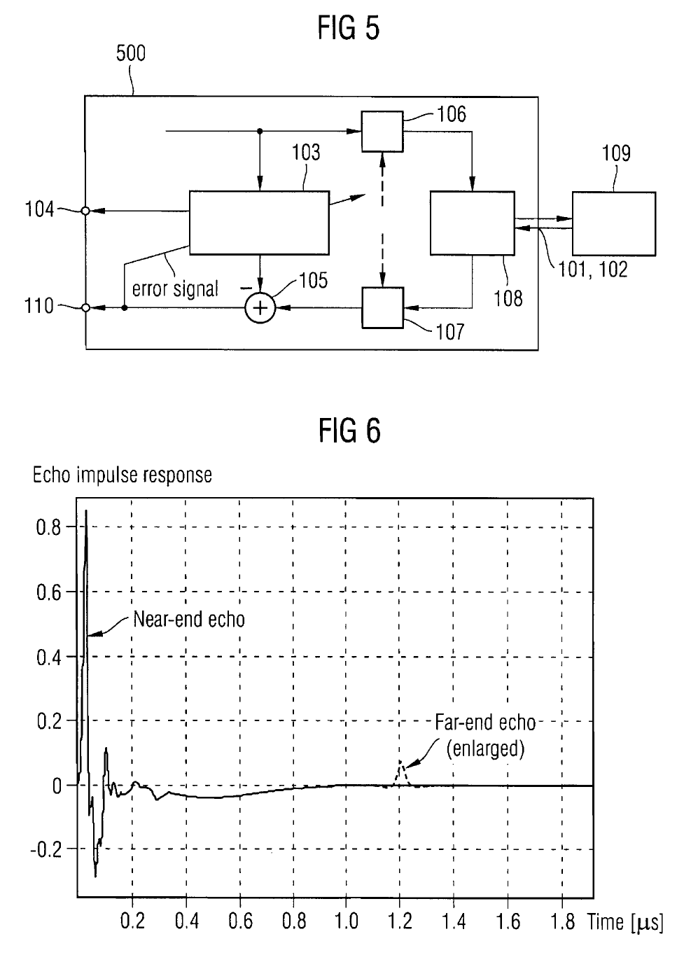

Information on the length of the transmission line 109 and the existence of bridged taps as well as other useful data can be derived from the far-end echo signal. However, as can be seen from FIG. 6 which shows the impulse response of an echo signal, the far-end echo is much more attenuated in comparison with the near-end echo. (For the ease of understanding, the far-end echo signal is enlarged in FIG. 6).

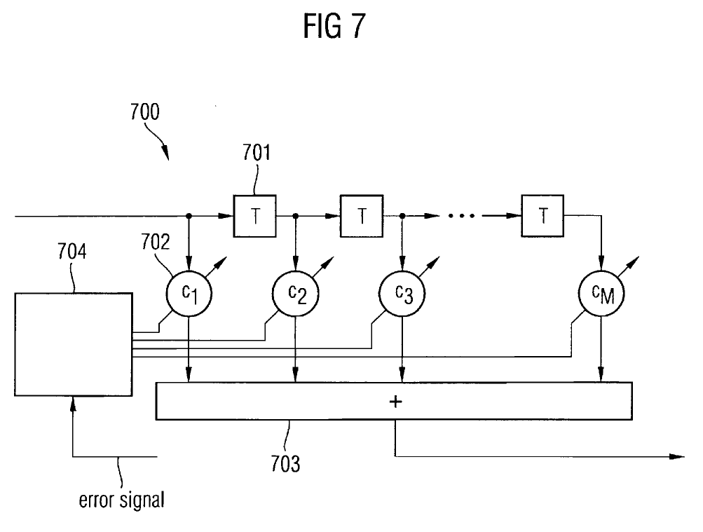

When operating the device 500, the first signal to be transmitted over the transmission line 109 is fed into the adaptive filter 103. The signal outputted by the adaptive filter 103 is subtracted from the received first echo signal by the adder 105. The error signal obtained from this subtraction is fed into the control terminal of the adaptive filter 103. The adaptive filter 103 may, for example, be constructed as an FIR (finite impulse response) filter. The circuit diagram of such an FIR filter 700 is schematically shown in FIG. 7. The FIR filter 700 comprises a plurality of delay elements 701, a plurality of multipliers 702, an adder 703 and a control unit 704. The control unit 704 receives the error signal from the adder 105 and selects the filter coefficients c₁ to c_{M} such that the error signal is minimized. The algorithm used to select the filter coefficients c₁ to c_{M} may, for example, be a least mean square algorithm. As a result, the adaptive filter 103 adjusts its filter coefficients c₁ to c_{M} to the impulse response of the first echo signal.

The filter coefficients c₁ to c_{M} are provided at the second output terminal 104, and the error signal is provided at the output terminal 110. In case the device 500 is coupled to the evaluation and control unit 402 as shown in FIG. 4, the evaluation and control unit 402 can use the provided filter coefficients c₁ to c_{M} to calculate primary parameters of the transmission line 109.

As it was already discussed above, the near-end echo may dominate the overall received first echo signal. In order to be able to detect the far-end portion in the first echo signal, the impulse response of the first echo signal should be measured with high accuracy. One approach to increase the measurement resolution may be to undertake several measurements and to average over the measurement results. Other approaches are to increase time resolution and/or to vary the examined frequency bandwidth. Both approaches are discussed in the following.

In order to increase the time resolution when detecting the first echo signal, transmitting the first signal and measuring the first echo signal may be repeatedly carried out, wherein the sampling phase of the analog-to-digital converter 107 is varied for each measurement. Thus, the result of each measurement is a set of filter coefficients c₁ to c_{M}, and each set is measured at a different sampling phase. The evaluation and control unit 402 may control the sampling phase of the analog-to-digital converter 107. The sampling rate of the analog-to-digital converter 107 may be pre-determined for all measurements.

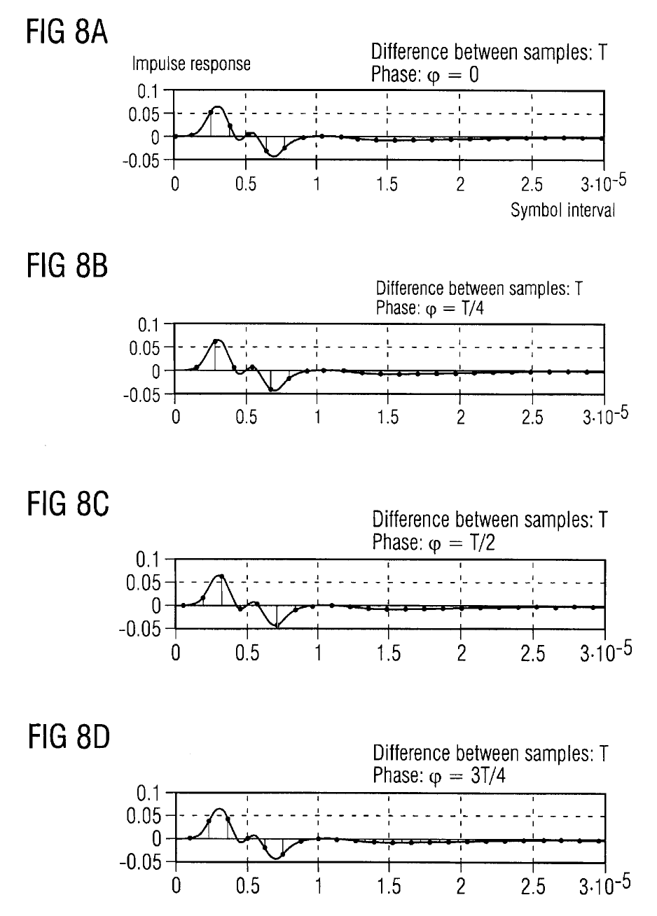

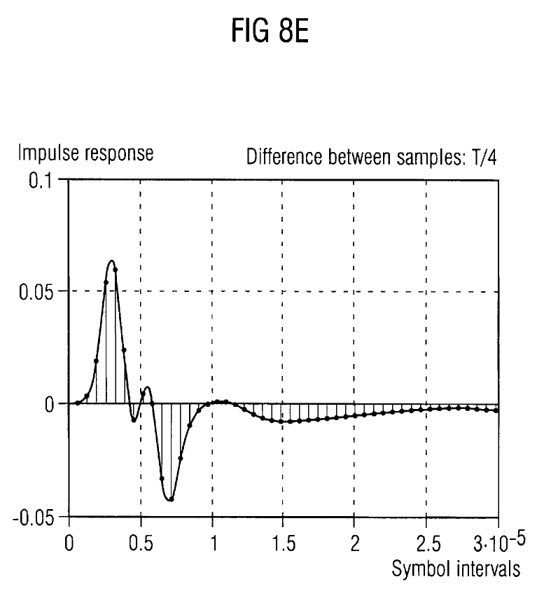

For example, the symbol rate may be f_{symbol}=1/T and the first echo signal may be sampled with the symbol rate so that the time difference between two successive sampling values is t=T. The filter coefficients c₁ to c_{M} may be measured with four different sampling phases φ, for example φ=0, φ=T/4, φ=T/2 and φ=3T/4. The four measured impulse responses are then combined to a single impulse response having a higher resolution. FIGS. 8A to 8E show an example of the above described measurement. The four phased-shifted echo impulse responses each having a time difference of t=T between successive sampling values (cf. FIG. 8A to 8D) are combined to a single echo impulse response with a time difference of t=T/4 between successive sampling values (cf. FIG. 8E). Combining several measured impulse responses to a single impulse response may be either carried out in the device 500 or in the evaluation and control unit 402.

A further approach to increase the accuracy of the measured impulse response of the first echo signal is to vary the examined frequency bandwidth. Variation of the frequency bandwidth can be carried out by varying the symbol rate of the first signal. The power of the near-end echo only slightly depends on the length of the transmission line 109, whereas the power of the far-end echo strongly depends on the length of the transmission line 109. The longer the length of the transmission line 109 is, the more attenuated the power of the far-end echo is. Furthermore, higher frequencies are subject to stronger attenuation. Therefore, it is possible to use a broad frequency bandwidth if the transmission line 109 is short. If the transmission line 109 is long, it is advantageous to use lower frequencies. The symbol rate of the first signal and thus the examined frequency bandwidth may be adjusted, for example, by the evaluation and control unit 402.

By way of example, the measurement of the echo impulse response may be started by transmitting first signals having a large frequency bandwidth. If the evaluation and control unit 402 then detects a long transmission line 109 to be connected to the device 500, the frequency bandwidth of the transmitted first signals is decreased. This focuses the measurements on frequency bands having lower attenuation so that, even in case of a long transmission line 109, the power of the first echo signal is big enough to be detected.

In order to calculate absolute values from the determined echo impulse responses, it is advantageous to determine the power the first echo signals when received at the device 500. The power of the first echo signals may be calculated from the gain factor of the analog-to-digital converter 107 and the gain factors of other amplifiers in the receiving path.

The filter coefficients of the adaptive filter 103 may be transferred to the evaluation and control unit 402 with a resolution of n bit. Since the received first echo signals are scaled by AGC (automatic gain control) amplifiers, the filter coefficients utilize the range to full capacity. In order to scale the filter coefficients, a scaling factor is transferred to the evaluation and control unit 402. The scaling factor may be determined from the gains of the AGC amplifiers. For example, the echo impulse response can be calculated as follows:

echo impulse response=scaling factor*filter coefficients (1)

The device 500 may, for example, be a transceiver used for data transmission and may be either installed in a central office or at the customer premises. During normal data transmission the adaptive filter 103 may be used for echo compensation. Only when properties of the transmission line 109 are evaluated, the device 500 may be used as described above. It is to be noted that in embodiments of the present invention the device 500 does not require an additional adaptive filter for evaluating the transmission line 109. Instead, the adaptive filter 103 of the echo canceler can be used for this purpose.

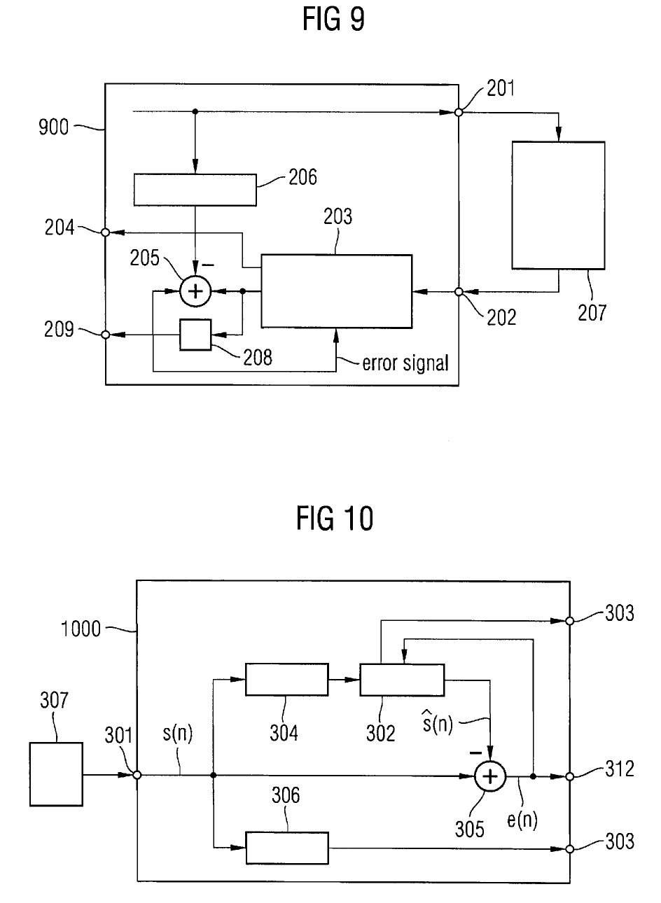

In FIG. 9 a schematic circuit diagram of a device 900 is illustrated. The device 900 represents an implementation of the device 200 shown in FIG. 2. The configurations of the device 900 described below may therefore be equally be applied to the device 200. In the device 900 the error signal generator 205 is implemented as an adder and a transmission line 207 is connected to the first output and input terminals 201, 202. Furthermore, the output signal of the adaptive filter 203 is fed into a decider 208 and the output signal of the decider 208 is provided at an output terminal 209.

In contrast to the device 500 shown in FIG. 5, the adaptive filter 203 forms an inverse model of the echo channel of the transmission line 207. The components of the device 900 are arranged such that the filter coefficients of the adaptive filter 203 represent the inverse echo impulse response. In the device 900, the first signals delayed by the delay element 206 instead of the received first echo signals are used to generate the error signal controlling the adaptive filter 203. This embodiment may, for example, be employed when the evaluation algorithm in the evaluation and control unit 402 determines the primary channel parameters based on the inverse echo impulse response (and not on the regular echo impulse response) or on a combination of the regular and the inverse echo impulse responses. The primary channel parameters would be less precise if the inverse echo impulse response is calculated from the regular echo impulse response.

The device 900 may, for example, be a transceiver used for data transmission either installed in a central office or at the customers premises. During normal data transmission the adaptive filter 203 may be used for equalizing received signals. When used as the adaptive filter of an equalizer, the output signal of the decider 208 is subtracted from the output signal of the adaptive filter 203 by the adder 205 in order to generate the error signal. However, when the adaptive filter 203 is used to evaluate the transmission link, the adaptive filter 203 of the equalizer is switched in a different way by using the delayed transmit symbols instead of the detected symbols in order to generate an error signal. Thus, one advantage of the device 900 is that it does not require an additional adaptive filter for evaluating the transmission line 207. Instead, the adaptive filter 203 of a linear equalizer can be used for this purpose.

In FIG. 10 a schematic circuit diagram of a device 1000 is illustrated. The device 1000 represents one implementation of the device 300 shown in FIG. 3. The configurations of the device 1000 described below may therefore be equally be applied to the device 300. Like the device 300, the device 1000 comprises a first input terminal 301, an adaptive filter 302, at least one first output terminal 303, a delay element 304, an error signal generator 305, which is presently implemented as an adder, and a determination circuit 306. In the present example, the first input terminal 301 is coupled to a transmission line 307. Furthermore, the error signal generated by the adder 305 is provided at an output terminal 312.

The transmission line 307 may be bundled together with other transmission lines within a cable. Due to the close proximity of the transmission lines within the cable, there is a considerable amount of noise caused by crosstalk interference between different neighboring transmission lines. Physically, there are two types of interference: near-end crosstalk (NEXT) and far-end crosstalk (FEXT).

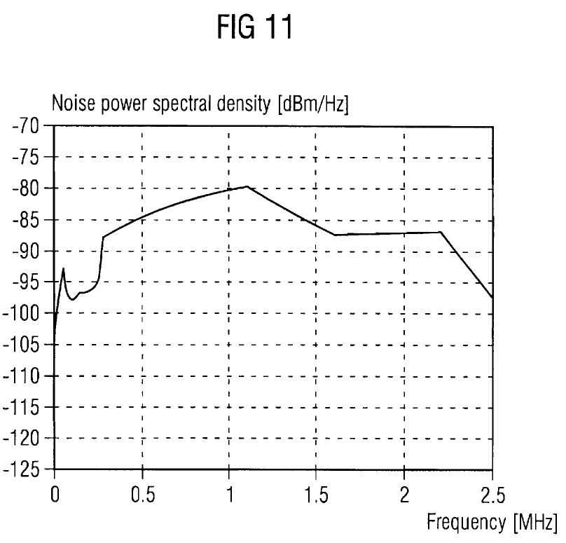

NEXT refers to interference between neighboring transmission lines that arises when signals are transmitted in opposite directions. FEXT refers to interference between neighboring transmission lines that arises when signals are transmitted in the same direction. Furthermore, other sorts of noise can be coupled to the transmission line 307 that is generated by other sources than neighboring transmission lines. This noise is called alien noise. As an example, FIG. 11 shows the noise power spectral density of a DSL transmission line.

The device 1000 receives a noise signal at the first input terminal 301. The noise signal can be considered as a steady-state, time-discrete and stochastic signal s(n). The function of the adaptive filter 302 is that of a predictor filter which means that the adaptive filter 302 predicts the current value of the stochastic signal received at the first input terminal 301. For that purpose, the adaptive filter 302 estimates the current sample of the stochastic signal by using a linear combination of previous samples. The predicted value s(n) outputted by the adaptive filter 302 is compared with the sample s(n) received at the first input terminal 301 by subtracting the estimated value s(n) from the real value s(n). The generated error signal e(n) is fed into the control input of the adaptive filter 302.

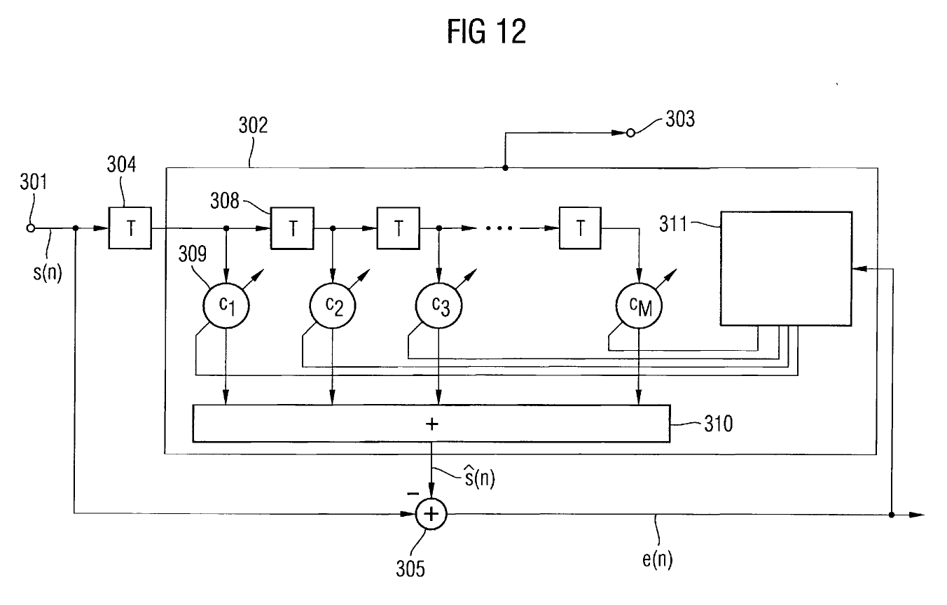

An embodiment of the adaptive filter 302 is schematically illustrated in FIG. 12. In this embodiment, the adaptive filter 302 is constructed as an FIR filter having a plurality of delay elements 308, a plurality of multipliers 309, an adder 310 and a control unit 311. The circuit shown in FIG. 12 is that of a prediction error filter and has an impulse response of g_{PEF}=[1−c₁ −c₂ . . . −c_{M}]. The control unit 311 employs a minimum mean-squared error algorithm to find an optimum set of filter coefficients c=[c₁ c₂ . . . c_{M}] used for the multiplication of the multipliers 309. The minimum mean-squared error algorithm seeks for the minimum of the mean-squared error P_{M}=E└|e(n)²┘ of the error signal e(n)=s(n)−ŝ(n).

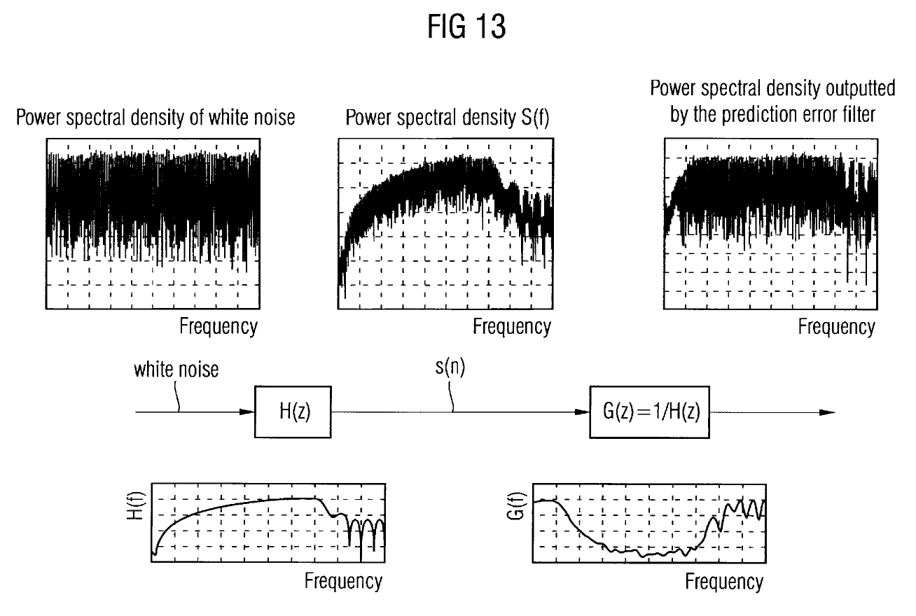

In the following a model of the noise signal occurring at the first input terminal 301 is presented. In this model, which is illustrated in FIG. 13, the noise power spectral density at the input terminal 301 is associated with a white noise signal that is filtered by a noise filter H(z). (Note that the noise filter H(z) is an imaginary filter. In a real system there is no noise filter.) Filtering the white noise signal by the noise filter H(z) results in the stochastic signal s(n) having a power spectral density S(f). The stochastic signal s(n) is filtered by the prediction error filter having a transfer function G(z). The transfer function G(z)=1/H(z) of the prediction error filter is inverse to the transfer function H(z) of the noise filter. Ideally, white noise should therefore be outputted by the prediction error filter. Furthermore, the transfer function G(z) of the prediction error filter depends on the transfer function C(z) of the adaptive filter 302:

G(z)=1−C(z) (2)

The noise power spectral density S(f) is proportional to the squared transfer function H(f) of the noise filter (S(f)∝|H(f)|²) with |H(f)|²=H(f)·H*(f*) and S(z)=const H(z)·H(1/z). The noise power spectral density S(f) may also be calculated as

$$S ( f ) = {σ}_{s}^{2} \cdot \frac{1}{{\vert G ( f ) \vert}^{2}} \qquad ( 3 )$$

wherein the variance σₛ² of the noise signal s(n) is equal to the power Pₛ of the noise signal:

Pₛ=σₛ² (4)

With the help of the equations (2) to (4), the evaluation and control unit 402 can calculate the noise power spectral density S(f) from the absolute value of the power Pₛ and the filter coefficients c₁ to c_{M}. For that purpose, the power Pₛ determined by the determination unit 306 and the filter coefficients c₁ to c_{M} are provided at the first output terminals 303.

Another approach to calculate the power spectral density of the noise signal is based on the autocorrelation function of the noise signal and is described in the following. The autocorrelation function r[m] of the time-discrete signal s[n] is

r[m]=E└s[n]·s*[n−m]┘ (5)

The power spectral density S(ω) is the discrete Fourier transform (DFT) of the sequence of the autocorrelation functions r[m]:

$$S ( ω ) = {\sum }_{m = - ∞}^{∞} r [ m ] \cdot {e}^{- j \cdot m \cdot ω \cdot T} \qquad ( 6 )$$

The absolute value of the power of the noise signal is equal to the autocorrelation function r[0]:

$$E [ \vert {x [ n ]}^{2} \vert ] = r [ 0 ] = \frac{T}{2 π} \cdot {\int }_{- \frac{π}{T}}^{\frac{π}{T}} S ( ω ) d ω \qquad ( 7 )$$

The linear equations describing the relation between the filter coefficients c₁ to c_{M} of the adaptive filter 302 and the autocorrelation functions are the so-called Yule Walker (Wiener Hopf) equations:

R·c′=r (8)

When using matrices and vectors equation (8) can be written as:

$$[ \begin{matrix}r [ 0 ] & r [ 1 ] & r [ 2 ] & ⋯ & r [ M - 1 ] \\ {r}^{*} [ 1 ] & r [ 0 ] & r [ 1 ] & ⋯ & r [ M - 2 ] \\ {r}^{*} [ 2 ] & {r}^{*} [ 1 ] & r [ 0 ] & ⋯ & r [ M - 3 ] \\ ⋮ & ⋮ & ⋮ & ⋰ & ⋮ \\ {r}^{*} [ M - 1 ] & {r}^{*} [ M - 2 ] & {r}^{*} [ M - 3 ] & ⋯ & r [ 0 ]\end{matrix} ] \cdot [ \begin{matrix}{c}_{1} \\ {c}_{2} \\ {c}_{3} \\ ⋮ \\ {c}_{M}\end{matrix} ] = [ \begin{matrix}r [ 1 ] \\ r [ 2 ] \\ r [ 3 ] \\ ⋮ \\ r [ M ]\end{matrix} ] \qquad ( 9 )$$

The Yule Walker equations may be solved by using the algorithm according to Levinson and Durbin. The power Pₑ of the error signal e(n) is

Pₑ=r(0)−r·c′ (10)

The variance σₛ² of the noise signal s(n) is equal to the autocorrelation function r(0) since s(n) has zero mean. The absolute value of the power of the noise signal may be measured in the device 1000 by the determination unit 306. By using the Levinson Durbin algorithm, the autocorrelation functions r(n) may be calculated from the filter coefficients c₁ to c_{M} if r(0) and Pₑ are known. Therefore Pₑ is also transferred to the evaluation and control unit 402.

The frequency bandwidth of the measured noise power spectral density is determined by the sampling rate of the receiving path and/or the symbol rate of the adaptive filter 302. The frequency bandwidth of the noise signal may be varied by varying the sampling rate in the receiving path.

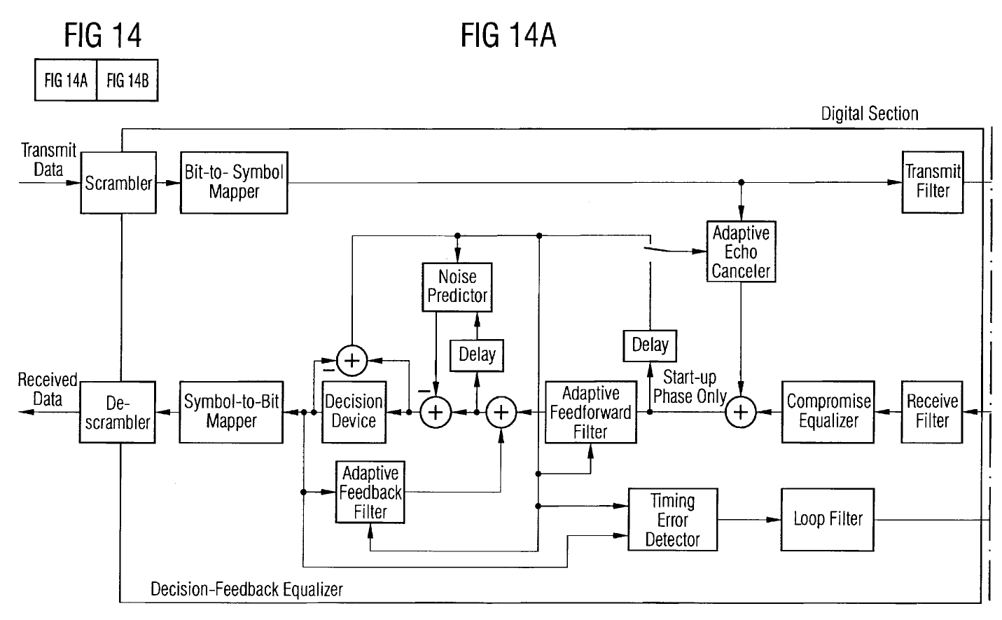

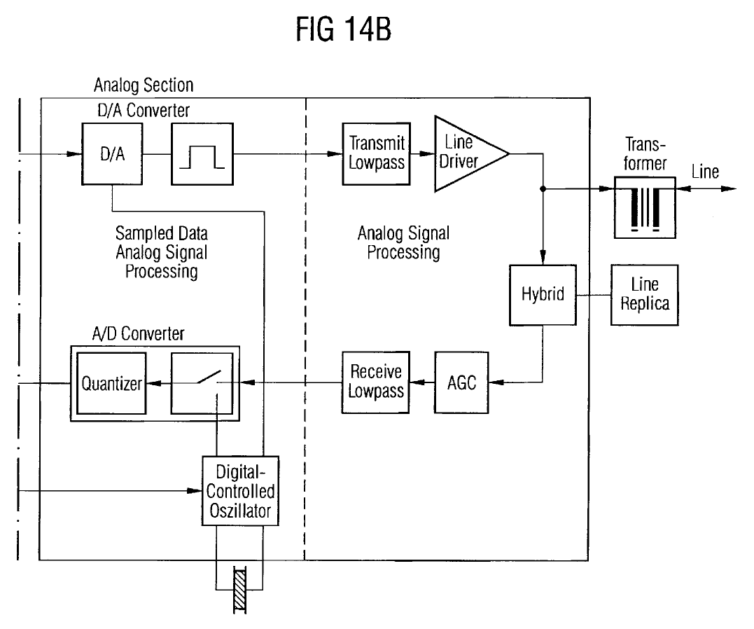

In the devices 100, 200, 300, 500, 900 and 1000, many components of these devices are components of a conventional transceiver and can be used also for implementing the embodiments of the present invention. As an example, in FIG. 14 a schematic circuit diagram of a transceiver is shown which uses DSL as service for transmitting data over the transmission line and PAM (Pulse-Amplitude Modulation) for modulating signals. For the adaptive filters 103, 203 and 302 adaptive filters may be used for measuring parameters during an evaluation phase which have other functions during normal data transmission. For example, the adaptive echo canceler, the equalizer and the noise predictor shown in FIG. 14 may be used as the adaptive filters 103, 203 and 302, respectively, during the evaluation of the properties of the transmission line.

In addition, while a particular feature or aspect of an embodiment of the invention may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. The terms “coupled” and “connected”, along with derivatives may have been used. It should be understood that these terms may have been used to indicate that two elements co-operate or interact with each other regardless whether they are in direct physical or electrical contact, or they are not in direct contact with each other. Furthermore, it should be understood that embodiments of the invention may be implemented in discrete circuits, partially integrated circuits or fully integrated circuits or programming means. Also, the term “exemplary” is merely meant as an example, rather than the best or optimal. It is also to be appreciated that features and/or elements depicted herein are illustrated with particular dimensions relative to one another for purposes of simplicity and ease of understanding, and that actual dimensions may differ substantially from that illustrated herein.

1. A device, comprising:
a first output terminal to provide a first signal to a transmission link;
a first input terminal to receive a first echo signal of the first signal;
an adaptive filter, coupled to the first input terminal and comprising a plurality of filter coefficients; and
at least one second output terminal to provide information identifying the filter coefficients of the adaptive filter.

2. The device of claim 1, further comprising an error signal generator to generate an error signal indicating whether the filter coefficients should be adjusted.

3. The device of claim 2, wherein the error signal generator has an output terminal coupled to a control terminal of the adaptive filter and input terminals coupled to the first input terminal and to an output terminal of the adaptive filter.

4. The device of claim 1, wherein the device is configurable to provide the information during an evaluation phase for measuring parameters of the transmission link.

5. The device of claim 3, further comprising an echo canceler, which comprises the adaptive filter.

6. The device of claim 2, further comprising a delay element having an input terminal to receive the first signal and an output terminal coupled to an input terminal of the error signal generator.

7. The device of claim 6, wherein a further input terminal of the error signal generator is coupled to an output terminal of the adaptive filter and an output terminal of the error signal generator is coupled to a control terminal of the adaptive filter.

8. The device of claim 6, wherein the adaptive filter adjusts its filter coefficients based on the inverse impulse response of the first echo signal.

9. The device of claim 6, further comprising an equalizer, which comprises the adaptive filter.

10. The device of claim 1, further comprising an analog-to-digital converter to sample the first echo signal, wherein a first control terminal is provided to set a sampling phase of the analog-to-digital converter.

11. The device of claim 1, wherein a second control terminal is provided to set a symbol rate of the first signal.

12. The device of claim 1, further comprising an evaluation unit, coupled to the second output terminal.

13. The device of claim 12, further comprising a control unit to control the coefficients of the adaptive filter.

14. The device of claim 12, wherein the evaluation unit determines at least one property of the transmission link using the filter coefficients of the adaptive filter.

15. The device of claim 14, wherein the at least one property of the transmission link is a length and/or a transfer function and/or a noise power spectral density of the transmission link.

16. A device, comprising:
a first input terminal to receive a noise signal from a transmission link;
an adaptive filter, coupled to the first input terminal and having a plurality of filter coefficients, to adjust its filter coefficients based on an impulse response of the noise signal; and
at least one first output terminal to provide the filter coefficients of the adaptive filter or signals related to the filter coefficients.

17. The device of claim 16, further comprising an error signal generator to generate an error signal indicating whether the filter coefficients should be adjusted.

18. The device of claim 17, wherein the error signal generator has an output terminal coupled to a control terminal of the adaptive filter and input terminals coupled to the first input terminal and to an output terminal of the adaptive filter.

19. The device of claim 16, further comprising a delay element having an input terminal coupled to the first input terminal and an output terminal coupled to an input terminal of the adaptive filter.

20. The device of claim 16, further comprising a prediction error filter, which comprises the adaptive filter.

21. The device of claim 16, further comprising a determination circuit, coupled to the first input terminal, to determine the power of the noise signal.

22. The device of claim 21, wherein the power of the noise signal is provided at the at least one first output terminal.

23. A method, comprising:
transmitting a first signal over a transmission link;
receiving a first echo signal of the first signal;
adjusting filter coefficients of an adaptive filter; and
calculating at least one property of the transmission link by using the filter coefficients of the adaptive filter.

24. The method of claim 23, further comprising:
transmitting a second signal over the transmission link;
receiving a second echo signal of the second signal;
sampling the second echo signal at a sampling phase different from the sampling phase used for sampling the first echo signal;
adjusting the filter coefficients of the adaptive filter based on an impulse response of the second echo signal; and
calculating the at least one property of the transmission link by using the filter coefficients obtained from the first and second echo signals.

25. The method of claim 23, further comprising:
transmitting a second signal over the transmission link, wherein a symbol rate of the second signal is different from a symbol rate of the first signal;
receiving a second echo signal of the second signal;
adjusting the filter coefficients of the adaptive filter based on an impulse response of the second echo signal; and
calculating the at least one property of the transmission link by using the filter coefficients obtained from the second echo signal.

26. The method of claim 23, wherein the at least one property of the transmission link is a length and/or a transfer function and/or a noise power spectral density of the transmission link.

27. A method, comprising:
receiving a noise signal from a transmission link;
adjusting filter coefficients of an adaptive filter based on an impulse response of the noise signal; and
calculating at least one property of the transmission link by using the filter coefficients of the adaptive filter.

28. The method of claim 27, wherein the power of the noise signal is determined and the at least one property of the transmission link is calculated by using the power of the noise signal.

29. The method of claim 27, wherein the at least one property of the transmission link is a length and/or a transfer function and/or a noise power spectral density of the transmission link.
